(19) United States
(12) Patent Application Publication
(10) Pub. No.: US 2011/0058377 A1
(43) Pub. Date: Mar. 10, 2011

(54) LED illumination device capability of increasing lighting illumination

(76) Inventors: Meng Hsieh Chou, Sinjhuang City (TW); Yen Wei Pen, Sinjhuang City (TW); Ming Xian Lin, Sinjhuang City (TW); Yen Chi Wu, Sinjhuang City (TW)

(21) Appl. No.: 12/703,771

(22) Filed: Feb. 11, 2010

(30) Foreign Application Priority Data
Sep. 10, 2009 (TW) 098130479

(51) Int. Cl. F21V 29/00

(52) U.S. Cl. 362/294

(57) ABSTRACT

An LED illumination device capability of increasing illumination comprises a heat sink base, an LED illumination module which has a print circuit board and LEDS arranged at the print circuit board, a reflecting board and a transparent board. The LED illumination module is mounted on the heat sink base. The reflecting board has a plurality of holes which correspond to the LEDS of the LED illumination module, so that the LEDS may be exposed through the holes of the reflecting board. And the transparent board is located on the upper surface of the heat sink base to cover the LED illumination module.

### FIELD OF THE INVENTION:

The present invention relates to an LED illumination device capability of increasing lighting illumination, and in particular to an LED illumination device may reflected light to increase the lighting illumination.

### DESCRIPTION OF THE RELATED ART:

Since light emitting diodes (LEDS) feature the high brightness, power saving and long life expectancy advantages, they have been used extensively for the illumination of lamps. Several LED lamps are usually connected to form an LED lamp set, and the position of each lamp can be adjusted to achieve an illumination effect to meet the requirements for a large projecting area and a high brightness. These LED lamp sets are used as illuminating devices indoors and outdoors. However, it is necessary to plan the LED lamps and the layout of different projecting areas, so as to differentiate the projecting area for each LED lamp with a different distance from the LED lamp and the projecting area, and prevent an uneven brightness of the light projected from the LED lamps onto the projecting areas. Therefore, it is an important subject for manufacturers in the related field to design an LED lamp with good directionality and even brightness,

As is generally known in the art, use has been made of varying kinds of illumination lamps for lightening or illuminating objects at night or indoors. Such illumination lamps are supplied with electric energy from a power source and convert the electric energy to light energy, thereby producing a beam of light for illumination. Typical examples of the illumination lamps include a glow lamp and a fluorescent lamp.

Widely used in recent years is a Light Emitting Diode (LED) illumination lamp that has a benefit of providing illumination of different colors, although higher in price than the typical lamps referred to above. However, the LED illumination lamp poses a drawback in that it tends to be heated up and shows decreased efficiency when used for more than a predetermined time period. Use of the LED lamp for a prolonged period of time may result in excessive heat generation, thus shortening the life span of the lamp,

### SUMMARY OF THE INVENTION

An object of the present invention is to provide an LED illumination device capability of increasing lighting illumination,

To achieve the above-mentioned object, the present invention includes a heat sink base, an LED illumination module which has a print circuit board and LEDS arranged at the print circuit board, a reflecting board and a transparent board. The LED illumination module is mounted on the heat sink base, The reflecting board has a plurality of holes which correspond to the LEDS of the LED illumination module, so that the LEDS may be exposed through the holes of the reflecting board. And the transparent board is located on the upper surface of the heat sink base to cover the LED illumination module,

### BRIEF DESCRIPTION OF THE DRAWINGS

FIG. 1 is an exploded view of an LED illumination device capability of increasing lighting illumination of the present invention

FIG. 2 is a cross-sectional view of assembly drawing of the FIG. 1.

FIG. 3 is a schematic view of the FIG. 2,

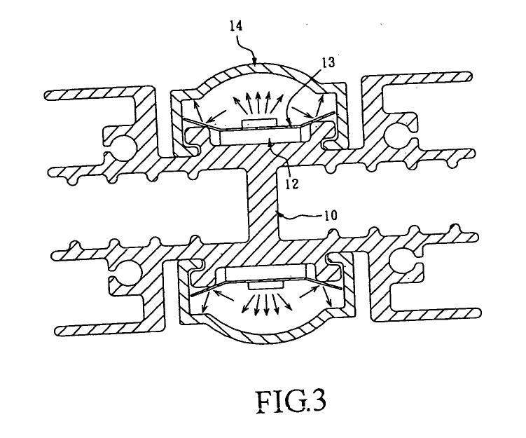

### DETAILED DESCRIPTION OF THE. INVENTION

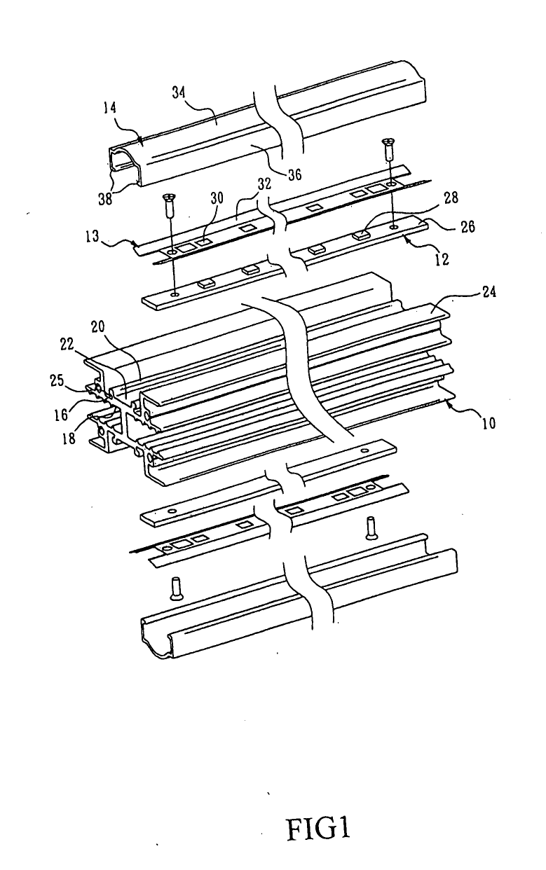

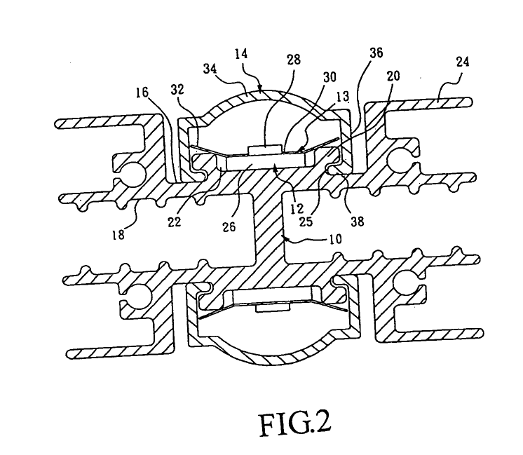

As can be seen in FIG. 1 and FIG. 2, an LED illumination device capability of increasing lighting illumination of the present invention includes a heat sink base 10, an LED illumination module 12, a reflecting board 13 and a transparent board 14. Wherein

The heat sink base 10 has an upper surface 16, which is formed with two flange 20 located at both side of the upper surface 16 to form a cavity 22, wherein the external sides of the flange 20 are formed with heat sink sheets 24 respectively. Since the both side of the upper surface 17 of the heat sink 10 are formed with slots 25 respectively.

The LED illumination module 12, which includes a printed circuit board 26 and a plurality of LED 28 are located on the print circuit board 22.

The reflecting board 13 is mounted on the upper surface 16 of the heat sink base 10, and is formed with a plurality of holes 30 correspond to the LEDS 28 of the LED illumination module 20, so that LEDS 28 may be exposed through the holes 30 of the reflecting board 13. Further the both side of the reflecting board 13 are formed with bending board 32 toward the transparent board 40, wherein the bending board 32 of the reflecting board 13 is located on the flange 20 of the heat sink base 10. And

The transparent board 14 is a [symbol] -shape, which has a top board 34 and two side board 36 arranged at the both side of the top board 34, the lower end of the two side board 36 are formed with a guide rail 38 respectively, so that the guide rail 38 of the side boards 36 of the transparent board 14 may be guided within the slots 25 of the heat sink base 10, so that the transparent board 14 may covered the LED illumination module 12.

Please refer to FIG. 2, while the light from the LED illumination module 12 is reflected by the transparent board 14, the reflected light may be reflected by the reflecting board 13, therefore the present invention may increases lighting illumination.

While the present has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modification.

What is claimed is:

1. An LED illumination device capability of increasing lighting illumination comprising
A heat sink base having an upper surface and a bottom surface
An LED illumination module having a printed circuit board and LEDS arranged at the print circuit hoard, wherein the printed circuit board is mounted on the upper surface of the heat sink base ;
A reflecting board having a plurality of holes which correspond to the LEDS of the LED illumination module, so that the LEDS may be exposed through the holes of the reflecting board ;
A transparent board located on the upper surface of the heat sink base to cover the LED illumination module.

2. The LED illumination device capability of increasing lighting illumination according to claim 1, further comprising two flanges arranged at both side of the upper surface of the heat sink base to form a cavity, wherein LED illumination module is located within the cavity.

3. The LED illumination device capability of increasing lighting illumination according to claim 2, further comprising heat sink sheets formed at the external side of the flanges,

4. The LED illumination device capability of increasing lighting illumination according to claim 1, wherein the both side of the reflecting board is formed with bending sheet toward the transparent board.

5. The LED illumination device capability of increasing lighting illumination according to claim 1, wherein the transparent board is a [symbol] -shape, which has a top board and two side boards arranged at the both sides of the top board, the two side boards are fixed at the upper surface of the heat sink base.

6. The LED illumination device capability of increasing lighting illumination according to claim 5, wherein the both sides of the heat sink base are formed with a slot respectively, so that the side boards of the transparent board is fixed at the slots of the heat sink base.

7. The LED illumination device capability of increasing lighting illumination according to claim 6, wherein the side boards of the transparent board are formed with guide rail , which is guided within the slot of the heat sink base.
